(19) United States
(12) Patent Application Publication
(10) Pub. No.: US 2008/0041456 A1
(43) Pub. Date: Feb. 21, 2008

(54) Air Vent

(75) Inventor: Rainald Dumrath, Balgach (CH)

Correspondence Address: VOLPE AND KOENIG, P.C., UNITED PLAZA, SUITE 1600, 30 SOUTH 17TH STREET, PHILADELPHIA, PA, 19103, US

(73) Assignee: IMT ARMATUREN AG, Au (CH)

(21) Appl. No.: 11/570,546

(22) PCT Filed: Jun. 28, 2005
(86) PCT No.: PCT/EP05/06944

§ 371 Date: Dec. 13, 2006

(30) Foreign Application Priority Data
Jun. 29, 2004 (DE) 10 2004 031 225.7

(51) Int. Cl. F16L 55/07

(52) U.S. Cl. 137/176

(57) ABSTRACT

An air vent (1) for heating systems is provided that includes a float valve inside a vent housing (6). The float valve is placed upstream of an air-outlet opening. The air vent includes a float (4) which is displaceably guided inside the vent housing (6) and which interacts with the float valve, and has a cap or bell-shaped design. Air is evacuated from the interior of the cap or bell-shaped float (4) via at least one vent opening (7). The vent housing (6) has an inlet opening (12) that leads into the float interior. The air vent is characterized by its comparatively compact design and trouble-free functioning of the float valve located inside the vent housing (6).

### BACKGROUND

The invention relates to an air vent for heating systems, comprising a float valve inside a vent housing, which is placed upstream of an air-outlet opening.

In the new installation or during the repair of a hot-water heating system, the air inside the pipes must be allowed to evacuate when the hot water flows in. It is already known to provide individual valves at radiators for venting air from the heating systems, which can be opened via a key for evacuating the air. Due to the fact that the individual valves at the individual radiators have to be opened separately from each other and be closed again after the ventilation of the respective radiator the process of evacuating the air can be rather time consuming and laborious.

Therefore, rapidly operating air vents have been designed provided with a float valve inside an air vent housing, which is placed upstream of an air-outlet opening. In order to be able, during the rising of the water flowing into the heating system, to automatically close the air-outlet opening of the air vent via the float valve, the air vent of prior art must usually be arranged at the highest location of the heating system.

The ventilation of the heating system with the help of air vents of prior art occurs largely automatically and therefore it saves a considerable amount of time in reference to conventional individual valves. However, there is the problem that the location of the valve may become leaky by potentially contaminated water in the pipes so that water exits the air vent and potentially causes water damage.

Therefore, various air vents have been designed, in which the closing mechanism of the float valve is separated from the level of the medium contained in the air valve housing, so that the medium and particularly the potentially entrained dirt particles cannot reach the closing mechanism. This is achieved in the marketed air vents by a respective distance of the level of the medium from the locking mechanism of the float valve. This distance has to be very large, though, because splashing develops by the formation of bubbles and/or by the rapidly inflowing medium, which also may entrain contaminants.

### SUMMARY

Therefore, the particular object is to provide an air vent of the type mentioned at the outset which is characterized in a comparatively compact design and still ensures trouble-free functionality of the float valve inside the air vent.

The object is attained according to the invention in the air vent of the type mentioned at the outset particularly in that the float, guided in a displaceable manner in the air vent housing and cooperating with the float valve, is embodied in a cap or bell shape, that the interior float space of the cap or bell shaped float is ventilated via at least one air outlet opening, and that the vent housing has an inlet opening that discharges into the interior float space.

Here, a preferred embodiment according to the invention provides for the float extending over a filter insert provided in the area of the inlet opening, said filter insert having at least one filter opening that discharges into the interior float space and that the circumferential sleeve of the filter insert, below at least one filter opening, has an encircling throttle or sealing surface, which is contacted in its upper end position by an air throttle arranged in the area of the inlet opening.

The air entering the air valve and the subsequently flowing water must pass the air throttle of its inlet opening, in order to enter the interior of the air vent housing. When these media enter very rapidly and, in particular, when the air flows faster than the following water, the air throttle, which is mobile inside the air vent housing, is entrained and pressed against the throttle or sealing surface encircling the inside of the filter insert such that the inlet to the filter insert is temporarily closed and the influx process is interrupted. The air throttle falls back down by its “weight” so that the influx cycle can begin anew. The filter insert prevents the inflowing water of each influx cycle from rapidly reaching the closing mechanism; this simultaneously hinders large dirt particles, such as e.g., hemp or Teflon tape remnants, scales, or larger rust particles, to further enter the air valve housing through the filter insert and reach the float valve. The air flowing through the filter insert can penetrate the interior float space via its filter opening. From here the air, slowed down by the outlet in the float of the air vent, reaches the area of the float valve and its closing mechanism. Any entrained water can drain down at the float or at the interior wall at the air valve housing. In this manner a trouble-free functionality of the float valve inside the air vent is ensured, with the air vent according to the invention also being characterized in a comparatively compact design.

A particular further development according to the invention comprises the air vent being designed in a modular fashion and, for this purpose, a filter insert is allocated to it, which optionally can be inserted into the inlet opening that discharges into the interior float space.

A preferred embodiment according to the invention provides that at least one ventilation opening is arranged at the circumferential sleeve of the float at a distance below its top or the tip of its cap. In order for the float not to react too sluggishly when the water table rises quickly due to rapidly inflowing media the air flowing into the air vent is used to temporarily reduce the unit weight of the float and thus allows it to react more quickly. Due to the fact that the float outlet opening is arranged at a distance below its cap or the tip of its cap, the air bubble forming below the cap or the tip of the cap temporarily provides the necessary buoyancy force.

It is particularly advantageous for the filter insert to have at least one filter opening in the upper and the lower partial section of its longitudinal extension. This further promotes the separation of air and water because the air regularly exits the filter insert through the upper filter opening, while the water can also flow through the lower filter opening.

It is useful for the filter insert to be provided with at least one filter opening in the form of a slit aligned in the longitudinal direction of the filter insert. The slit-shaped embodiment of this filter opening avoids a complete clogging of the filter opening.

The exemplary embodiment according to the invention provides for the float and the air vent housing to limit at least one pipeline for liquids, which preferably connect the section of the interior float space arranged above the float with the section arranged below the float. The water displaced by the inflowing air in the area of the float valve can therefore flow back into the filter insert via the channel for liquids between the float and the air vent housing. Due to the fact that the air can therefore rise at the inside through the filter insert to the float valve, while at the outside the water is displaced downwards, any undesired eddying of air and water is largely avoided, in reference to conventional air vents, and a separation of air and water is achieved.

A particularly simple and advantageous embodiment according to the invention provides for the filter insert to have a circular stop at an interior circumference thereof, with its circular surface facing the air throttle that is embodied as a throttle or sealing surface. In order for the air throttle to safely and tightly contact the filter insert in its upper final position it is advantageous for the air throttle to be provided with a circular stop or a circular flange with its circular surface facing the filter insert being embodied as a throttle or sealing counter-surface.

Here, a preferred embodiment according to the invention provides for the air throttle with its circular flange between the circular stop of the filter insert and a stop surface of the air valve housing adjacent to the inlet opening to be mobile.

In order for the inflowing air and the subsequently flowing water to pass the inlet opening of the air valve unresisted it is useful for at least one spacer to be provided at the circular space of the air throttle facing away from the filter insert.

In order to clean the air valve when necessary and to clear it from any potential contaminants it is advantageous to provide a closing valve or a shut-off between the heating system and the air vent.

In order to counteract the undesired formation of bubbles in the air vent housing a preferred embodiment according to the invention provides that the air throttle is provided with a preferably rod-shaped bubble poker, protruding at the side facing the filter insert and/or facing away from the filter insert.

### BRIEF DESCRIPTION OF THE DRAWINGS

Further features of the invention are discernible from the following description of an exemplary embodiment of the invention in connection with the claims as well as the drawings. The individual features can be implemented by themselves or in combination in an embodiment according to the invention.

Shown are:

FIG. 1 a longitudinal cross-sectional view of an air valve for a heating system, which air valve is provided with a filter insert at the inside of the housing, and

FIG. 2 a longitudinal cross-sectional view of an air valve according to FIG. 1, with the air valve being used without a filter insert.

### DETAILED DESCRIPTION OF THE PREFERRED EMBODIMENTS

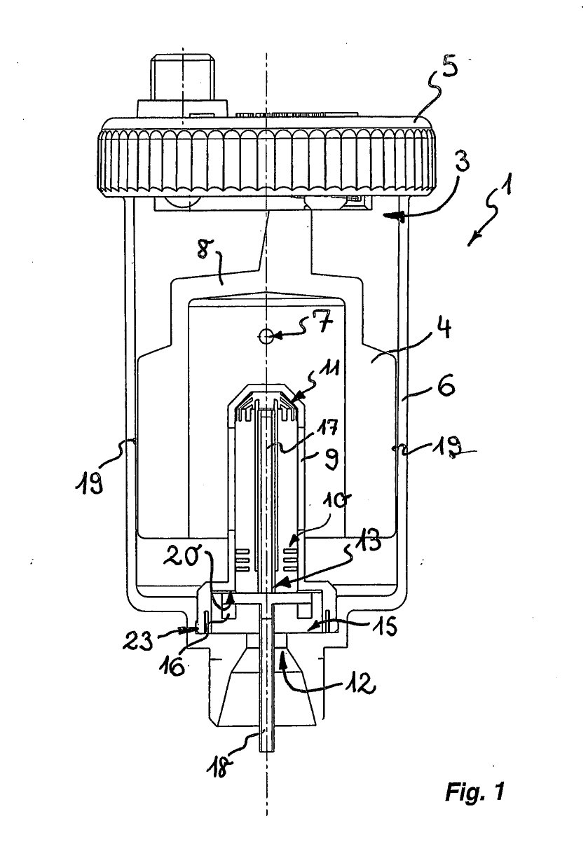

In FIG. 1 an air valve 1 is shown in a longitudinal cross-section. The purpose of the air valve 1 is to ensure an automatic evacuation of the air trapped inside the pipes, for example during a repair process or the new installation of a water heating system. For this purpose the air valve is provided with a float valve, not shown in greater detail, here, which is located upstream of an air outlet opening and cooperates with a float 4 via a closing mechanism 3. The float valve is integrated in a housing lid 5, which can be screwed onto the air valve housing 6.

The float 4, which is guided in a displaceable manner in the air vent housing 6, is embodied cap or bell—shaped. The interior float space of the cap or bell-shaped float 4 can be ventilated via at least one air-outlet opening 7, which is arranged here at the circumferential sleeve of the float 4 at a distance below the top 8 of the float.

The float 4 covers a cylindrical filter insert 9, which has at least several filter openings 10, 11 discharging into the interior float space. These filter openings 10, 11 are partially arranged in the upper and partially in the lower section of the longitudinal extension of the filter insert and are each embodied as filter slits 10, 11 aligned in the longitudinal direction of the filter insert 9.

At the circumferential sleeve of the filter insert 9, below the filter openings 10, a throttle or sealing surface 20 is provided, contacted by the air throttle 13 in its upper final position in an area of the influx opening 12 of the air valve 1. This throttle or sealing surface 20 is formed by the circular surface of a circular stop pointing downwards, which is provided at the interior circumference in the lower part of the filter insert 9. The throttle and sealing surface 20 of the filter insert 9 cooperates with a throttle or sealing counter—surface, which is provided by the circular flange 14 at the upper circular surface of an air throttle 13 facing the filter insert.

The air throttle 13 can be moved with its circular flange 14 between the circular stop of the filter insert 9 and a stop 15 of the air vent housing 6, limiting the inlet opening 12. In order for the inflowing air and the following water to pass the air throttle 13 at the inlet opening 12 several spacers 16 are provided at a regular circumferential distance from each other at the circular surface of the air throttle facing away from the filter insert 9.

The air throttle 13 is provided, both at the side facing the filter insert 9 as well as at the side facing away from the filter insert 9, with a central rod-shaped bubble poker 17, 18 each, which protrudes beyond the two provided circular surfaces of the circular flange 14 and counteracts any potential formation of air bubbles.

The air entering the air vent 1 and the subsequent flowing water must pass the inlet opening 12 to the movable air throttle 13 in order to reach the interior of the air vent 1. When these media enter very rapidly and in particular when the air flows faster than the water, the movable air throttle 13 is entrained upwards and seals the entry to the filter insert at the sealing surface 20 such that the influx process is interrupted. By its weight the mobile air throttle 13 falls back down and the influx cycle starts anew.

The filter insert 9 hinders the larger dirt particles entrained in the water or the air from entering the air vent 1. Here, after the system has calmed, particles heavier than water sink back down into the lower section of the filter insert 9 and, with a high probability, are rinsed out at the subsequent ventilation cycle. However, airborne particles remain stuck in the upper part of the filter insert 9. The upper and lower filter openings 10, 11 are embodied as filter slits, distributed over a larger vertical area of the longitudinal extension of the filter insert in order to largely hinder a complete clogging of the filter insert 9. The filter insert 9 is filled from the top downwards. If necessary, the filter insert can be cleaned. For this purpose, a closing valve or a shut-off is provided between the air valve 1 and the heating system allowing a temporary disassembly of the air valve without interrupting the functionality of the heating system. Temporarily disassembled from the heating system and particularly its filter insert 9, the air valve 1 can be easily cleaned under running water and/or easily be shaken out.

The lower filter openings 10 and the upper filter openings 11 divide the filter insert 9 into two functional sections, in which it is permeable by air and water. Here, the air flowing into the filter insert 9 is regularly released through the upper filter openings 11 into the interior float space of the cap or bell—shaped float 4. From the interior float space the air enters the area of the float valve and its closing mechanism 3 through preferably several small, laterally arranged and precisely dimensioned air-outlet openings 7 in a slowed down manner. Any potentially entrained water drips to the exterior area of the float 4, sloping down or to the lateral interior wall of the air vent housing 6 and runs down there.

The water displaced by the air flowing in always flows from the area of the closing mechanism 3 through the channel 19 for liquids, which is limited by the exterior of the float 4 and the interior wall of the air vent housing 6. The displaced water can flow back into the filter insert 9 through the lower filter openings 10. This achieves that the air and water separate, i.e. it facilitates that the air rises at the inside and the water flows down at the outside. Through these features, undesired eddies of air and water are largely avoided, differing from conventional air vents.

The cap or bell shaped embodiment of the float 4 and the air passage limited by the air outlet openings 7 from the interior float space to the area of the closing mechanism 3 ensure that, in case larger amounts of air entering, the specific weight of the float 4 is reduced by the temporarily trapped air and the float first opens the closing mechanism by rising rapidly and closing the air outlet openings. The air reaches the area with the closing mechanism 3 only slowly through the lateral, precisely dimensioned air-outlet openings 7 in the float 4, with the water table dropping and the air-outlet opening being reopened.

The air valve 1 shown here avoids the issue that the water used as the heating medium can rapidly enter the interior of the air valve 1 after evacuation and, by the inertia of the float 4, reach the closing mechanism 3. By the filter insert 9 provided in the air vent 1, large dirt particles are hindered from entering the air vent and, in particular, the area of the float valve. The float 4 cooperating with the filter insert 9 provided therein to separate the inflowing air from subsequently flowing water and effectively counteracts any splashing of water against the closing mechanism. By the cap or bell-shaped embodiment of the float and the air bubble located below its cap or the tip of its cap the specific weight of the float can temporarily be reduced such that it can react rapidly even when air flows in quickly and water subsequently rushes in. Here, the air vent 1 is characterized by its very compact construction height. Due to the fact that the advance of the dirt particles to the closing mechanism 3 is counteracted, any leaks of the air valve shown here are avoided. Since neither water nor water splashes can advance to the closing mechanism 3 no water can exit from the air valve 1, either.

The air throttle 13 closes the air-intake opening 12 even under high speed of the inflowing air and the entrained water and portions these media. The filter insert 9 functions not only as a filter but also guides the inflowing air in a targeted manner through its upper filter openings 11 into the interior float space of the cap or bell-shaped float 3, with the displaced water being guided off via the lower filter openings 10, separate from the air. The float 4 and the bubble formed below the tip of its cap or the cap allows quick activation of the closing mechanism 3 to close the air outlet opening when larger amounts of air enter. By the special embodiment of the filter insert 9, the float 4, and by the targeted guidance of air and water the air vent 1 offers triple protection against an undesired formation of air bubbles and water splashes. By the balance of the system, the air vent 1 stabilizes and calms the movements of the mobile parts and thus additionally contributes to a calmer ventilation of the heating system, which in turn prevents water and/or dirt from reaching the closing mechanism 3.

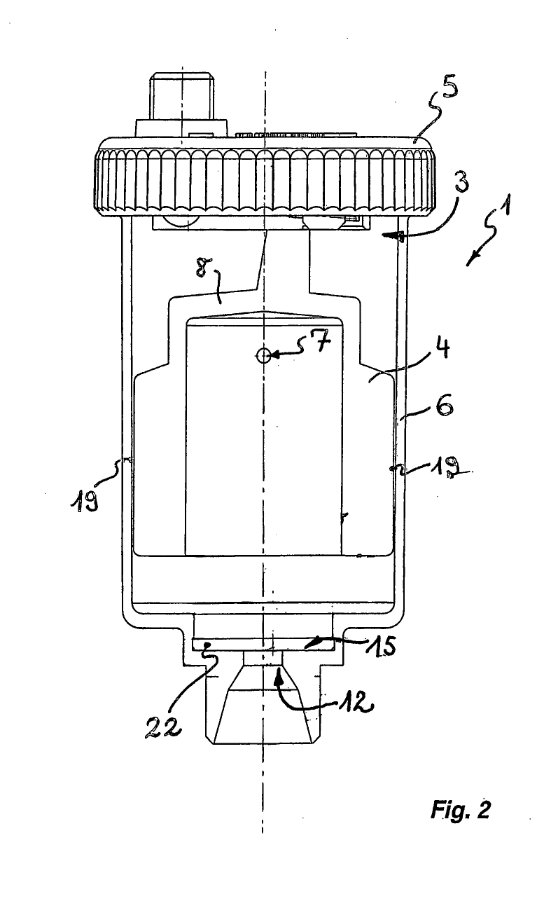

Comparing FIGS. 1 and 2, it is discernible that the air vent 1 is designed in a modular fashion. For this purpose, the filter insert 9 allocated to the air valve 1 can be removed from the interior of the housing of the valve housing 6, and the air vent 1 can also be used without a filter insert. While the air vent 1 in FIG. 1 is provided with a filter insert 9, the filter insert 9 in FIG. 2 has been removed, if necessary, from the vent housing 6 of the air vent 1. It is discernible from FIG. 2 that the filter insert 9 is held in the vent housing 6 via a snap connection etc. in a detachable manner. For this purpose, the vent housing 6 is provided with a pot-shaped receiving opening, which accepts the section of the filter insert 9 facing the inlet opening 12. In the area of the stop surface 15, forming the bottom of the pot of the pot-shaped receiving opening, an encircling snapping groove 22 is provided cooperating with at least one snap on the filter insert 9.

1. An air vent (1) for heating systems comprising a float valve in an air vent housing (6), which is located upstream from an air-outlet opening, having a cap or bell-shaped float (4) guided in a displaceable manner in the air vent housing (6) that cooperates with the float valve, an interior float space of the cap or bell-shaped float (4) is ventilated via at least one air outlet opening (7), and the air vent housing (6) has an inlet opening (12) that discharges into the interior float space of the cap or bell-shaped float (4).

2. An air vent according to claim 1, wherein the float (4) covers a filter insert (9) provided in an area of the inlet opening (12), which has at least one filter opening (10, 11) that discharges into the interior float space, and a circumferential sleeve of the filter insert (9) is provided with at least one circumferential throttle or sealing surface (20) located below the at least one filter opening (10, 11), which is connected by an air throttle (13) arranged in an area of the inlet opening (12) in an upper end position thereof.

3. An air vent according to claim 2, wherein the air vent (1) is modular and the filter insert (9) is insertable into the inlet opening that discharges into the interior float space.

4. An air vent according to claim 1, wherein the at least one air inlet opening (7) is arranged on a circumferential sleeve of the float (4) at a distance below a top (8) of the cap.

5. An air vent according to claim 2, wherein the filter insert (9) has a filter opening (10, 11) in each of an upper and a lower section of a longitudinal extension thereof.

6. An air vent according to claim 2, wherein the filter insert (9) is provided with at least one slit-shaped filter opening (10, 11) aligned along a longitudinal direction of the filter insert (9).

7. An air vent according to claim 1, wherein the float (4) and the air vent housing (6) limits at least one channel for liquids (19), connecting a partial area of the interior float space, arranged above the float (4) with a partial area of the interior float space arranged below the float.

8. An air vent according to one of claims 1 through 7, characterized in that the filter insert (9) has a circular stop at an interior circumference thereof, with a circular surface facing the air throttle that is embodied as a throttle or sealing surface (20).

9. An air vent according to claim 2, wherein the air throttle (13) has a circular stop or a circular flange (14), with a circular surface thereof facing the filter insert (9) and being embodied as a throttle or sealing counter surface.

10. An air vent according to claim 9, wherein the air throttle (13) is movable and includes a circular flange between the circular stop of the filter insert (9) and a stop surface (15) of the air vent housing (6) limiting the inlet opening (12).

11. An air vent according to claim 10, wherein the circular surface of the air throttle (13) facing away from the filter insert has at least one spacer (16).

12. An air vent according to claim 1, wherein a closing valve or a shut-off is provided between the heating system and the air vent (1).

13. An air vent according to claim 2, wherein the air throttle (13) has a preferably rod-shaped bubble poker (17, 18) on a side facing towards the filter insert (9) and/or on a side facing away from the filter insert (9).
